(19) United States
(12) Patent Application Publication
(10) Pub. No.: US 2014/0207915 A1
(43) Pub. Date: Jul. 24, 2014

(54) COMPUTERIZED MEDIA INFORMATION STREAMING SYSTEM

(71) Applicants: Sanford Liu, Toronto (CA); Sandy Hurst, Toronto (CA); Elliott Hurst, Toronto (CA)

(72) Inventors: Sanford Liu, Toronto (CA); Sandy Hurst, Toronto (CA); Elliott Hurst, Toronto (CA)

(21) Appl. No.: 13/749,374

(22) Filed: Jan. 24, 2013

(51) Int. Cl. H04L 29/06

(52) U.S. Cl. CPC H04L 65/60
USPC 709/219

(57) ABSTRACT

A system for streaming information from one computer to another computer is disclosed. A player computerized system connects through a web interface server into a station community through a social networking website on the web interface server, wherein the station community has media information for a plurality of songs from a website online stream. The player computerized system determines at least one song of the plurality of songs that have the media information from the website online stream to post on the social networking website. At least one other player computerized system accesses the social networking website to obtain the post of the at least one song of the plurality of songs that have the media information from the website online stream. The at least one other player computerized system determines if the at least one song to post from the plurality of songs that have the media information from the website online stream is available to be streamed in real-time, if the at least one song to post from the plurality of songs that have the media information from the website online stream is available to be streamed in real-time then the at least one song is played on the at least one other player computerized system.

### FIELD OF THE INVENTION

The present invention relates to a computerized media information streaming system. More particularly this computerized streaming system enables a person to stream music, pictures information by linking one computer system through the Internet to another computer system.

### FIELD OF THE INVENTION

People throughout the world communicate with each other by using mobile phones, by texting, instant messaging, email or just the plain old phone call. They generally want to connect with each other to share how their daily lives are going, special events, notable events to provide an update to family friends and associates.

One of the many forms people have chosen to communicate is through social networking, such as Facebook, Twitter or any other social networking website. When these people choose to share real-time data through the social networking website the receivers of the real-time data may not be able to access it at a later date. The receiver of the Post may click on the Post, but they may not be able to receive the real-time data at a later date. Often times it is desired to ensure that if data, audio or video information is transmitted through a social networking website that the receiver will receive the audio or video information real-time data at a later date.

### SUMMARY OF THE INVENTION

The present invention has been accomplished in view of the above-mentioned technical background, and it is an object of the present invention to provide a computerized system for streaming information through a social networking website.

In a preferred embodiment of the invention, a system for streaming information from one computer to another computer is disclosed. A player computerized system connects through a web interface server into a station community through a social networking website on the web interface server, wherein the station community has media information for a plurality of songs from a website online stream. The player computerized system determines at least one song of the plurality of songs that have the media information from the website online stream to post on the social networking website. At least one other player computerized systems accesses the social networking website to obtain the post of the at least one song of the plurality of songs that have the media information from the website online stream. The at least one other player computerized system determines if the at least one song to post from the plurality of songs that have the media information from the website online stream is available to be streamed in real-time, if the at least one song to post from the plurality of songs that have the media information from the website online stream is available to be streamed in real-time then the at least one song is played on the at least one other player computerized system.

In another preferred embodiment of the invention, a system for streaming information from one computer to another computer is disclosed. A player computerized system connects through a web interface server into a station community through a social networking website on the web interface server, wherein the station community has media information for a plurality of songs from a website online stream. The player computerized system determines at least one song of the plurality of songs that have the media information from the website online stream to post on the social networking website. At least one other player computerized systems accesses the social networking website to obtain the post of the at least one song of the plurality of songs that have the media information from the website online stream. The at least one other player computerized system determines if the at least one song to post from the plurality of songs that have the media information from the website online stream is available to be streamed in real-time, if the at least one song to post from the plurality of songs that have the media information from the website online stream is unavailable to be streamed in real-time then the at least one other player computerized system accesses a special algorithm to retrieve the post of the at least one song from the plurality of songs that have the media information from the website online stream that is played at a video sharing website.

A system for streaming information from one computer to another computer. A player computerized system connects through a web interface server into a player website, where the player computerized system enters text on the player website to place onto a social networking website on the web interface server. The player computerized system connects through the web interface server into a station community through the social networking website on the web interface server, wherein the station community has media information for a plurality of songs from a website online stream. The player computerized system determines at least one song of the plurality of songs that have the media information from the website online stream to post on the social networking website, wherein the text is entered on the player website is synced to the at least one song of the plurality of songs that have the media information. At least one other player computerized system accesses the social networking website to obtain the post of the at least one song of the plurality of songs that have the media information from the website online stream. The at least one other player computerized system determines if the at least one song to post from the plurality of songs that have the media information from the website online stream is available to be streamed in real-time, if the at least one song to post from the plurality of songs that have the media information from the website online stream is available to be streamed in real-time then the at least one song is played with the synced text on the at least one other player computerized system.

### BRIEF DESCRIPTION OF THE DRAWINGS

These and other advantages of the present invention will become more apparent as the following description is read in conjunction with the accompanying drawings, wherein:

FIG. 1 is a block diagram of a first computer connected through a web interface to a second computer in accordance with the invention;

FIGS. 2A and 2B show a flow chart of how the first computer is utilized to transfer information through a social networking website to the second computer of FIG. 1 in accordance with the invention;

FIGS. 3A and 3B show example website pages with dialogue boxes showing the player software program utilized on a social networking website of FIG. 2 in accordance with the invention;

FIGS. 4A, 4B and 4C shows a flow chart of how the first computer is utilized to embed media information onto the SoCast dashboard to transfer information from the social networking website of the first computer to the social networking website of the second computer in accordance with the invention; and

FIGS. 5A, 5B and 5C shows example website pages of dialogue boxes embedding information on the social networking website of FIG. 4 in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

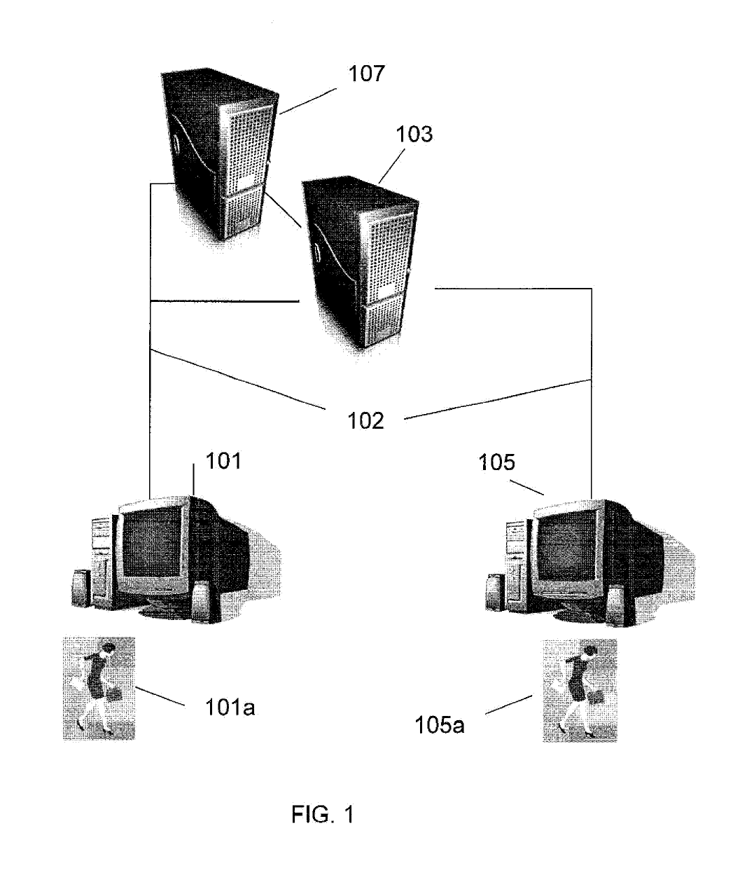

FIG. 1 is an illustration of a block diagram of an integrated computer streaming system. The computer streaming system 100 includes a first computer 101, a web interface server 103, a second computer 105 and a separate server 107. First computer 101 and second computer 105 are connected through a communication link, such as Internet 102 to the web interface server 103 and separate server 107. The communication link 102 may be a local access network (LAN), wireless access network, wide area network (WAN), a virtual area network, wireless fidelity (Wi-Fi) network, Bluetooth, an Ethernet link, a satellite link, cable link, cellular, fiber-optic or any network that can facilitate the transfer of information between computer systems. Web interface server 103 and separate server 107 are typical computer servers utilized as a simple and universal interface between web servers, computers and web applications. Separate server 107 also acts as a storage device that stores information associated with the SoCast player software program.

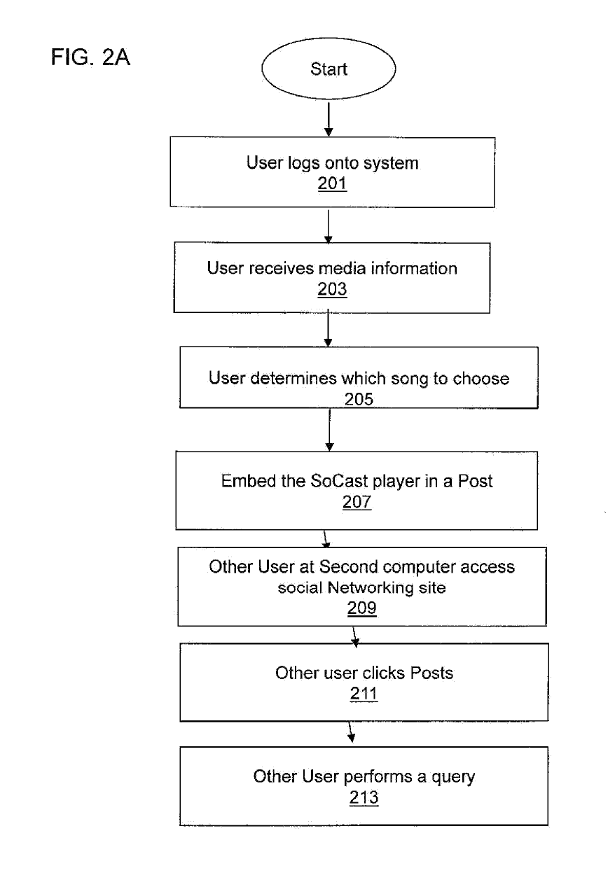

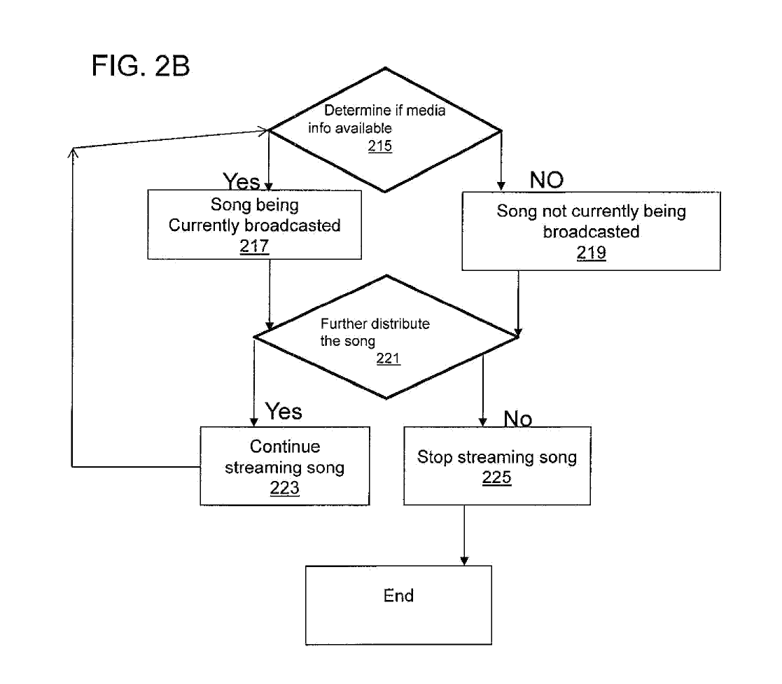

First computer system 101 includes an actual person 101a that utilizes the computer 101. Also, the first computer 101 may be any type of computer system including a desktop, laptop, notebook, mobile computer system, a tablet computing system, cell phone, smartphone or any type of computing system. In addition, first computer 101 includes one or more user input devices, such as a keyboard, buttons, switches, mouse, track wheels or click wheels utilized by user 101a to input information into the first computer 101. First computer 101 may be a plurality of computers from 1 to 100 computers or more that includes a processor, mass storage and memory. Also, first computer 101 includes a file streaming software program referred to as SoCast player software program stored on the processor which will be described in various embodiments in FIGS. 2A, 2B, 3A, 3B, 4A, 4B, 4C, 5A, 5B and 5C.

Second computer 105 or other player 105, which is connected to the first computer 101 by the Internet 102 and web interface server 103, may be any type of computer system including a desktop, laptop, notebook, mobile computer system, a tablet computing system, cellular phone, smartphone or any type of computing system. This second computer 105 is equivalent to the first computer 101 includes one or more user input devices, such as a keyboard, buttons, switches, mouse, track wheels or click wheels utilized by user 105a to input information into the second computer 105. Second computer 105 may be a plurality of computers from 1 to 100 computers or more that includes a processor, mass storage and memory. The second computer 105 includes a file streaming software program referred to as SoCast player software program stored on the processor which will be described in various embodiments in FIGS. 2A, 2B, 3A, 3B, 4A, 4B, 4C, 5A, 5B and 5C.

First computer 101 and second computer 105 may also include a radio station's online stream or web online stream, which is connected directly into the audio board at the station. For this embodiment, the internet standard is a real time messaging protocol (RTMP) utilized for streaming audio, video and data over the Internet between a Flash player and a server. The SoCast player software program utilizes this RTMP and plays it through speakers of the first computer 101. This online stream of music will not be saved on first computer 101. This radio station can broadcast radio station information such as Radio Data System (RDS) information. The RDS information can include, for example, digital information such as station identification, the current song's track, artist, genre, and length information, and/or alternative frequencies for particular station. The first computer 101 and second computer 105 can identify a broadcast media or segment using any suitable approach. In an embodiment, the first computer 101 and second computer 105 can monitor each radio station and retrieve data describing each broadcast media item, such as metadata information. Further, the first computer 101 and second computer 105 can identify media information provided by a radio station from various sources, such as a counterpart Internet radio station of a terrestrial or Internet radio station. Second computer 105 may be referred to as the at least one other player computerized system or at least one second player.

FIGS. 2A and 2B show a flow chart of how the first computer streams media information with the second computer by utilizing the software streaming program referred to as the SoCast Player software program. At block 201, a person 101a (FIG. 1) or user utilizes the information SoCast Player software program stored on first computer 101. User 101a turns ON first computer 101 that accesses the Internet through any typical web browser, such as Internet Explorer, Google Chrome, Mozilla in order to go to a social networking website on website interface server 103. The social networking website may be Facebook, LinkedIn, Twitter or any other available social networking website.

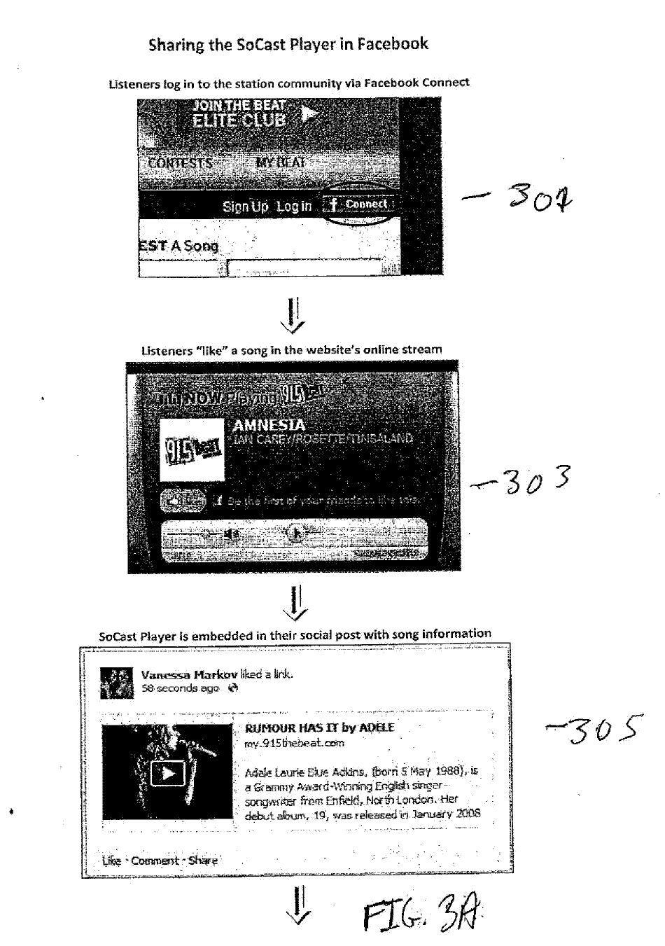

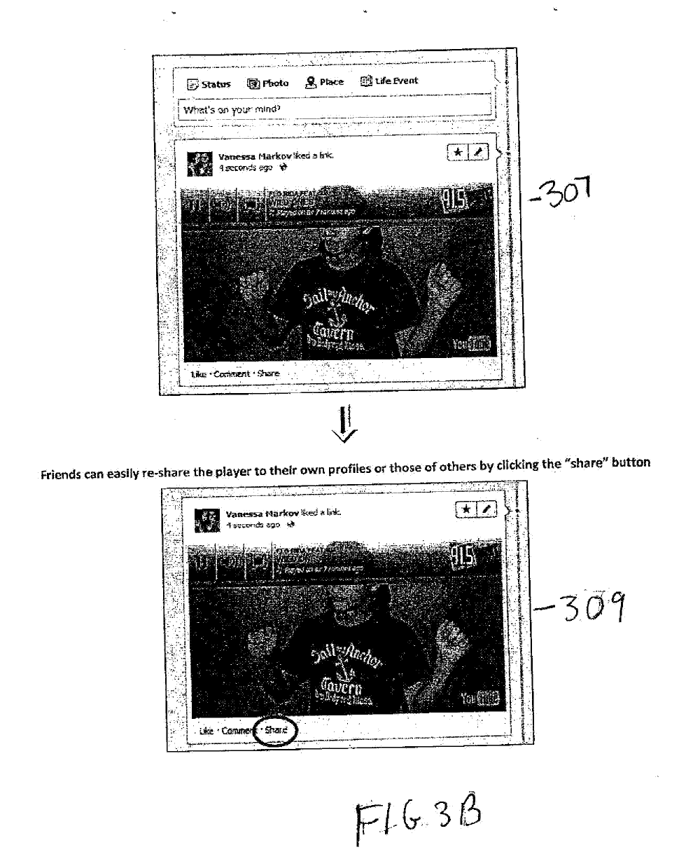

While at block 201 the user is at the social networking website then user 101a logs onto a station community at the social networking site. The station community is an Online Community Management Tool that integrates application program interface (API) from all major social networks into a database. For example, the user 101a logs onto the station community by clicking on the “Connect with Facebook” (FIG. 3A) button, that prompts the user 101 to utilize his/her Facebook username and password to login into the station community. FIG. 3A provides an illustration of the user utilizing the SoCast player program on the first computer 101 at dialogue box 301 where the user 101a logs onto the station community. The station community of a typical social networking website exists in two places: either as a page within a radio station or television station's website or within the radio station or television station's social networking website page. In this example, the station's website may be http://my.915the beat.com or within the station's Facebook page, which is http://www.facebook.com/91.5 thebeat/app_{—}320978571261369 the user logs into the station community as shown in dialog box 303 of FIG. 3A.

Referring to FIG. 2A, at block 203, when the user 101a is at first computer 101 the user 101a receives media information via online stream at the station community. The term media information can be any audio or video that may be broadcasted by a source, such as a first computer 101, and received by the electronic device or second computer 105. In addition, the media information may include music, advertisements, news programming, a podcast, videos, television show, musical performance, artist name, artist date of birth, artist album release date, artist biographical information, artist tour schedules, artist status update (Tweet) or any other media information that can be provided to the user 101a or user 105a. The broadcast may include a multitude of different segments, such as music or talk segments, news segments, weather segments, sports segments, traffic segments, or any other type of segments. User 101a is able to receive the online stream that is broadcasted as an internet standard. For this embodiment, the internet standard is a real time messaging protocol (RTMP) utilized for streaming audio, video and data over the Internet between a Flash player and a server. The SoCast player software program utilizes this RTMP and plays it through speakers of the first computer 101. This online stream of music will not be saved on first computer 101.

At block 205, the user 101a determines at least one song to choose, “pick” or “like” or “chosen” a song from a plurality of songs in an online stream or website online stream of the station community. Songs can be liked in two locations such as: 1. within the user's 101a Facebook Newsfeed or 2. on one of the community pages of the station community previously described above. Within the Facebook Newsfeed, the user 101a can see songs liked by his friend appear in their Newsfeed as a story. For example, Your friend Vanessa Mirkov (Name) just liked “Rumour Has It” (Song Name) by Adele (Artist Name) on 91.5Fm (Radio Station or Television Station) with links to listen to the song, which loads the SoCast player and a link to “Like” the song. For the community page, other users can listen to the live radio stream and when they hear a song they like they can click the “Like” button that broadcasts a story out to their friend's Newsfeeds. In another embodiment, the user 101a may choose the song “We Found Love” by the Artist Rihanna.

At block 207, the SoCast player is embedded in a social Post, as shown in dialogue box 305 of FIG. 3A, with media information where the SoCast player is embedded in social post as a “story” when the user likes a song. The embedded social post includes metadata or metatag information. The term story is a specific kind of “post.” Media information may include an image of an artist, name of artist, video of an artist, birthday of artist, biographical information of artist, touring dates of artist, images of the artist, name of artist latest album and locations where album can be purchased.

At block 209, other user 105a at second computer 105 (FIG. 1), which also has the SoCast Player software program, accesses a social networking website, such as Facebook where the other user 105a sees a Post from user 101a to stream the song sent by user 101a. At block 211, the other user 105a clicks the “Post” button to listen to the streamed song, such as the “Rumour Has It” song by Adele sent to the other user 105a by user 101a or Vanessa. At block 213, other user 105a at second computer 105, utilizes the Artist name Adele and song name “Rumour Has it” to query a station's broadcast history service via an application program interface (API). The API is utilized to determine if the Artist and song name of the song currently playing on air in real-time is equivalent or matches with the Artist and song name of the streamed song.

Referring to FIG. 2B, at block 215, the second computer 105 determines if the media information for song “Rumour Has It” by Adele is on the air and being currently broadcasted on the Internet radio station in real-time. Real-time is a narrative technique in which the events depicted take place entirely within the span of the depiction or real-time constraint and at the same rate.

At block 217, it is determined Yes that the song “Rumour Has It” is being currently played on the Internet radio station in real-time then the song is retrieved from the Internet radio station then played on the second computer 105. At block 219, the second computer 105 determines that the song is not being currently played or is unavailable in real-time then the SoCast player software program utilizes a special algorithm in order to retrieve the Posted example song “Rumour Has It” by Adele from the Internet or any other song chosen. The Artist Adele and song name “Rumour Has It” are normalized by this algorithm to remove or modify erroneous or superfluous data. For example, some stations add special characters to the artist name, such as an asterisk (*) or quotes (“) for internal reasons. These characters make the video search return bad results so these characters are removed by this algorithm. In addition, sometimes artist names contain additional featured artist, i.e. “CALVIN HARRIS feat FLORENCE WELCH” where the featured artist FLORENCE WELCH needs to be removed to perform a proper search for “CALVIN HARRIS” that includes artist biography and photos. The primary artist information “CALVIN HARRIS” is needed not the featured artist “FLORENCE WELCH.” The system separates artist names and searches them independently. Some characters and words don't perform as well with searches so they should be mapped to words more compatible with searches, for example, ampersand (&) should be replaced with the word “and.” Lastly, some artists are commonly misspelled and all variations must be checked, for instance “P!nk” is the official name but “pink” is often used. The SoCast software program includes a database of commonly misspelled names that do these translations.

Within the SoCast algorithm, the Artist “Adele” and the song name “Rumour Has It” by the Artist Adele are combined with extra filtering keywords in order to create a search phrase to send to the video sharing website application programming interface (API). This search phrase is used to return results of videos. The combination of filtering keywords is to search for the “Song Name by Artist Name” such as “Rumour Has it by Adele” followed by filters for “parody”, “cover”, etc. to remove less relevant videos. At this point, certain keywords are added, such as “official video” and “music video” to reinforce higher quality relevant. After the search is performed and results are received from the application programming interface, then the SoCast algorithm analyzes the videos and selects the first one that can be legally played in the listener's geographic region. For example, YouTube as well as other video sharing websites have particular licensing rules that prevent certain protected video from playing in certain regions. The Socast player software program opens video via an application program interface (API) and plays it embedded within the player of the second computer 105. The video is from a video sharing website such as YouTube/Vimeo that shows song information, as shown in dialog box 307 of FIG. 3B. For this example, the Artist is Florida and the song is “Wild Ones” showing artist and song can be streamed from first computer 101 to second computer 105.

In addition, the SoCast player software program will search on the Internet for information closely related to the Artist name and/or the artist song to be shown in text or played on the video sharing website, such as YouTube/Vimeo or any other video sharing website. Anytime an artist played live and/or Internet radio stream or YouTube/Vimeo on the SoCast player software program the artist name and song information is stored on a separate server on a database. In addition, anytime the artist is played on YouTube/Vimeo as part of the SoCast player software program the artist name and song information is also stored on the separate server 107 on a separate database. This database provides the date, time and the number of times the artist was played on the SoCast player software program and shown on YouTube/Vimeo, which can be readily provided to a record company, such as Defjam, ASCAP or any other entity in the business of tracking when an Artist's music is played or shown on YouTube. The sample database may look as follows:

| Artist | Song | Time Played | Device Played on |
|---|---|---|---|
| Adele | Rumour Has It | 2:51 pm on | Computer 105 |
| | | 1/7/2012 | |
| | | 3:01 am on | Computer 105 |
| | | 1/8/2013 | |
| Rihanna | We Found Love | 1:13pm on | Computer 101 |
| | | 12/28/2012 | |
| | | 3:51 pm on | Computer 105 |
| | | 12/29/2012 | |
| Florida | Wild Ones | 11:13am on | Computer 105 |
| | | 11/1/2012 | |
| | | 12:15pm on | Computer 105 |
| | | 11/30/2012 | |

At block 221, the user 105a determines if he wants to further distribute the song “Rumour Has It” by Adele in real-time to different users. At block 223 the other user 105a further distributes the song by clicking the “Like” button or “Share” button on second computer 105 as shown in dialogue box 309 (FIG. 3B) to send to different users then the process continues to block 215. At block 225 the user 105a decides not to send the song to more users then the process ends.

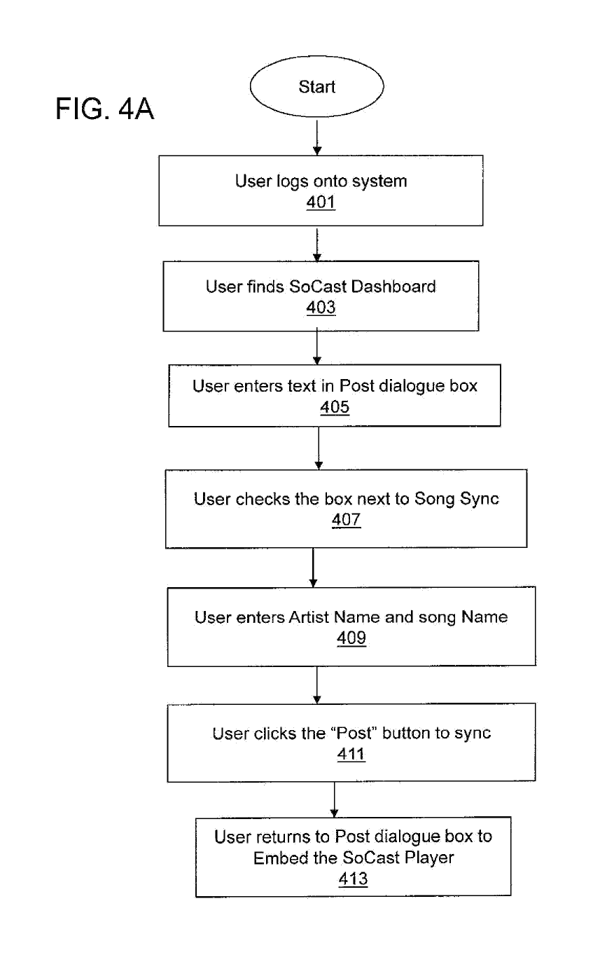

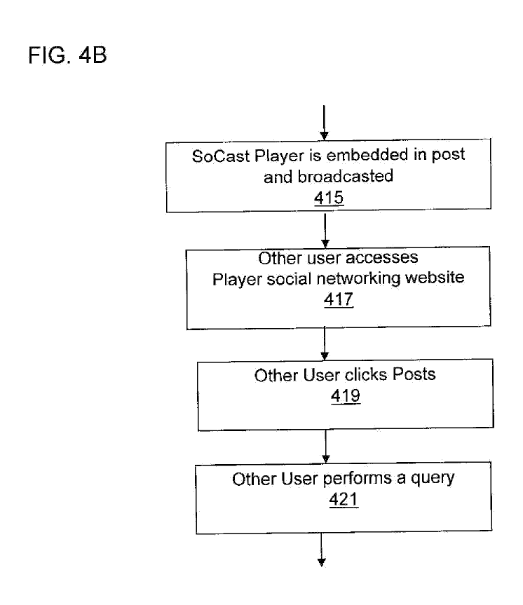

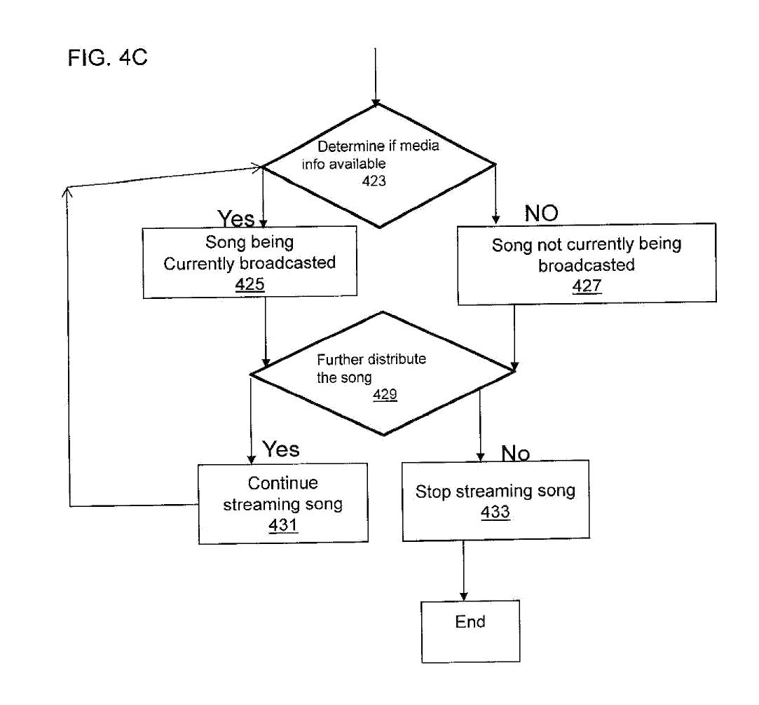

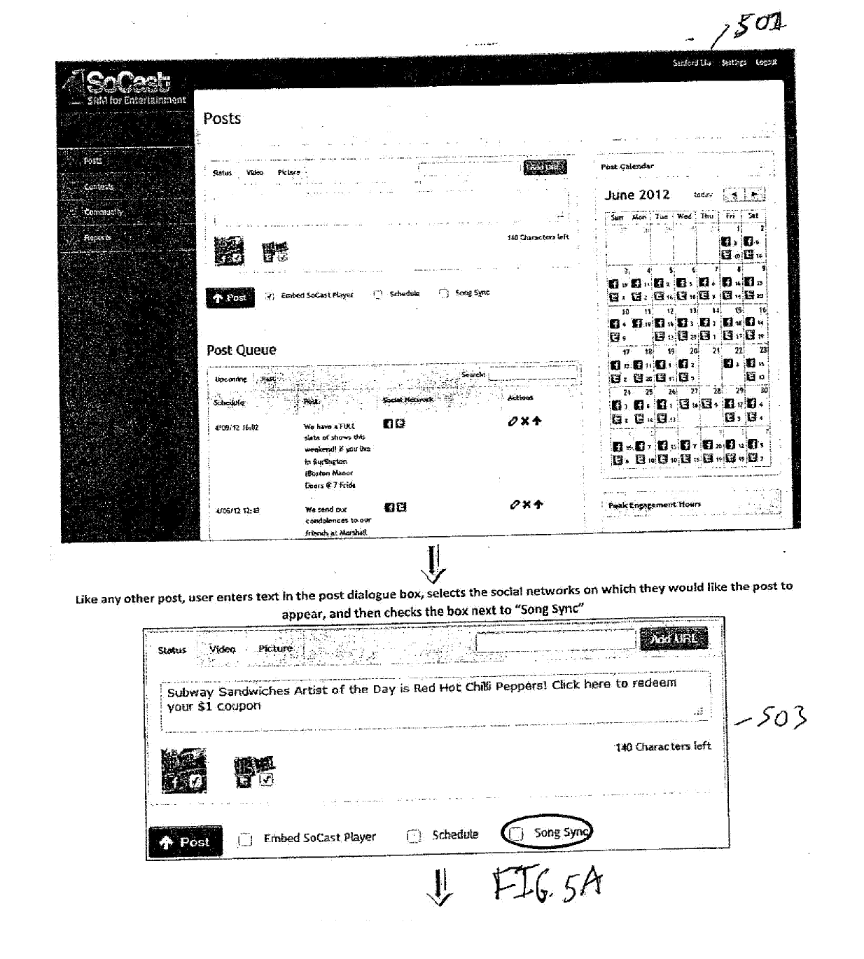

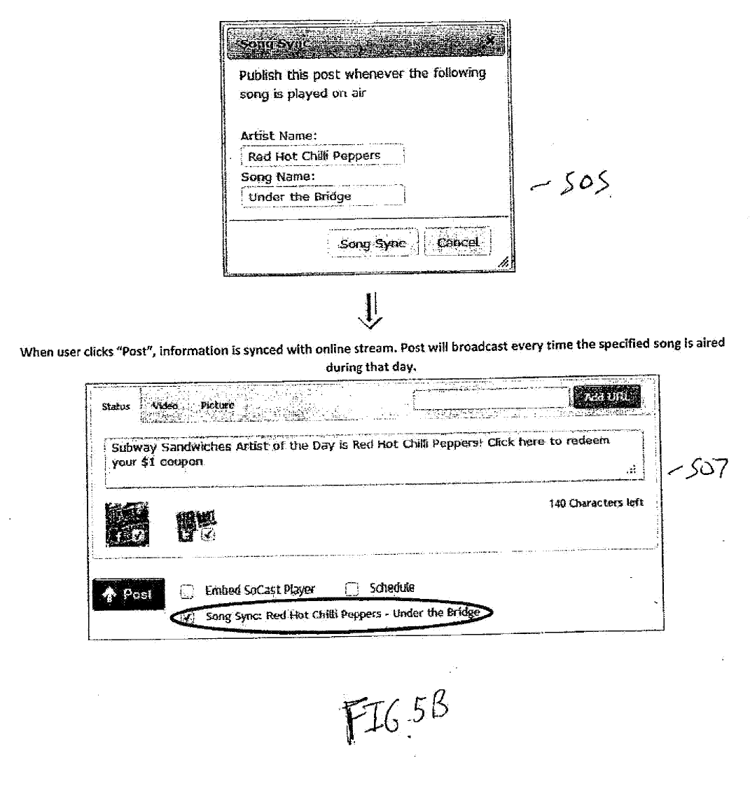

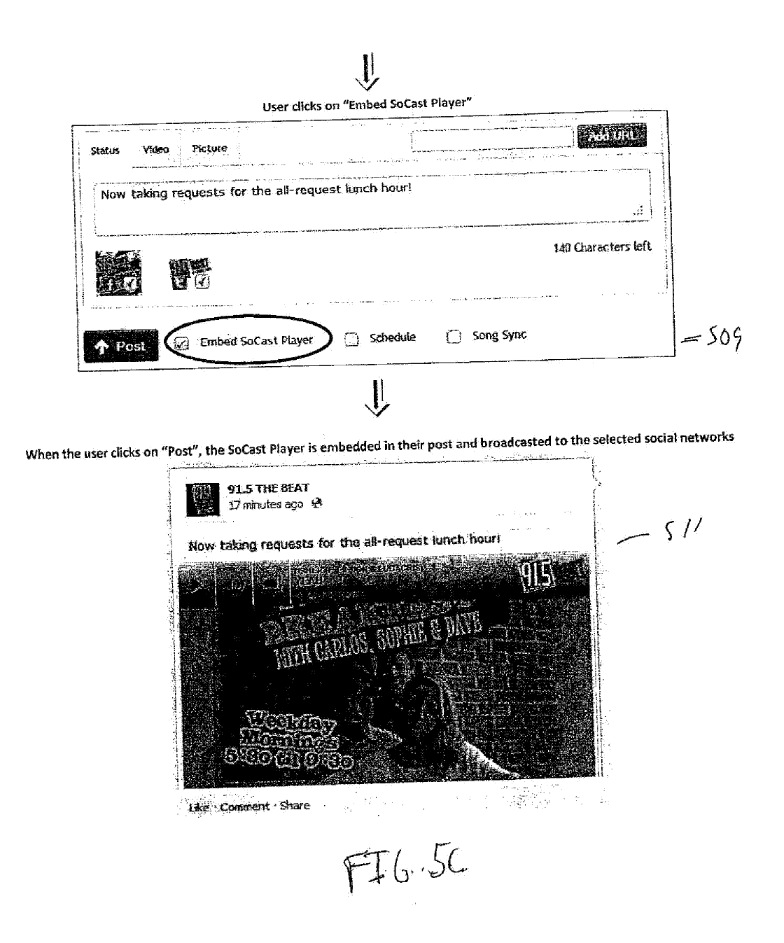

FIG. 4A shows a flow chart of how the first computer is utilized to embed text onto the SoCast dashboard to transfer information through the social networking website to the second computer of FIG. 1. At block 401, the person 101a turns ON first computer 101 that accesses the Internet through any typical web browser, such as Internet Explorer, Google Chrome, Mozilla to go to the SoCast website or player website. When the user 101a is at the SoCast website the user 101a finds the SoCast Dashboard or player dashboard. At block 403, the user 101a logs on to the SoCast Dashboard then clicks on the “Posts” button, as shown in dialogue box 501 of FIG. 5A.

Next, at block 405 the user 101a enters text in the “Post” dialogue box and then selects the social networking website on which the person wants the Post to appear. The social networking website, as described above may be LinkedIn, Facebook, Twitter or any other available social network website. The text may be any words and/or phrases the user chooses to post. For example, the user 101a may type the following text “Subway Sandwich Artist of the Day is Red Hot Chilli Peppers! Click here to redeem your $1 coupon.” As stated above, the internet standard is a real time messaging protocol (RTMP) utilized for streaming audio, video and data over the Internet between a Flash player and a server are utilized by computer 101 and computer 105 for this flow chart. User 101a at computer 101 utilizes the Internet radio, such as 91.5fm described above to obtain and stream the song “Under the Bridge” by the Artist “Red Hot Chilli Peppers” or any other song, such as “Yeah” by the Artist Usher featuring LiLJon and Ludacris.

At block 407, the user 101a checks the box next to Song sync as shown in dialogue box 503 of FIG. 5A. The Song sync feature allows the user 101a to Post the text such as “Subway Sandwiches Artist of the Day is Red Hot Chilli Peppers! Click here to redeem your $1 Coupon” each time the Artist Name: Red Hot Chilli Peppers and Song Name: Under the Bridge is played on computer 101 or any other computer, such as computer 105 that may receive the streamed Post of this song. For example, at block 409 the user 101a enters Artist Name of Red Hot Chilli Peppers and the Song Name: Under the Bridge at dialogue box 505 (FIG. 5B).

At block 411, the user clicks the “Post” button that syncs the text information with the Internet radio stream. The system checks the station's broadcast history of 91.5fm every minute to see if the song has changed. In this example, the song has changed to “Yeah” by the Artist Usher featuring LiLJon and Ludacris. If the song has changed, then the system checks if the song being played has been synced to a post. If the song has been synced then the post is published. The act of clicking “Post” will cause the text “Now taking request for the all-request lunch hour” to be posted every time the specified song, such as “Yeah” by the Artist Usher featuring LiLJon and Ludacris as shown in dialogue box 507 (FIG. 5B).

At block 413, the user 101a returns to the Post dialogue box then clicks on the “Embed SoCast Player” at dialogue box 509 (FIG. 5C) The text “Now taking requests for the all-request Lunch hour” is embedded with the song “Yeah” from the Artist Usher featuring LiLJon and Ludacris. Thus, every time the song “Yeah” by the Artist Usher featuring LiLJon and Ludacris is played the text “Now taking request for the all-request lunch hour!” may be displayed on the social networking website where this Post is played on computer 105 or other computers that plays this Post. Referring to FIG. 4B, Next, at block 415 after the user 101a clicks on the “Post” button the SoCast player is embedded in their Post and broadcasted to the selected social networks, such as Facebook, Twitter etc as shown in block 511 (FIG. 5C).

At block 417, user 105a at second computer 105 (FIG. 1), which also has the SoCast Player software program, accesses a social networking website, such as the SoCast website or player website. When the user 105 is at the SoCast website the user 105a finds the SoCast Dashboard or player dashboard where the other user 105a sees a Post from user 101a to stream the song “Yeah” embedded with the text “Now taking requests for the all-request lunch hour!” by the Artist Usher featuring LiLJon and Ludacris. At block 419, the other user 105a clicks the “Post” button to listen to the streamed song, such as the “Yeah” song by Usher featuring LiLJon and Ludacris sent to the other user 105a by user 101a. This song also includes the text “Now taking requests for the all-requests lunch hour!”

At block 421, other user 105a at second computer 105, utilizes the Artist name Usher featuring LiLJon and Ludacris and song name “Yeah” to query a station's broadcast history service via an application program interface (API). The API is utilized to determine if the Artist and song name of the song currently playing on air in real-time is equivalent or matches with the Artist and song name of the streamed song.

Referring to FIG. 4C, at block 423, the second computer 105 determines if the media information for song “Yeah” by Usher featuring LilJon and Ludacris is on the air and currently being broadcasted on the Internet radio station in real-time. Real-time is a narrative technique in which the events depicted take place entirely within the span of the depiction or real-time constraint and at the same rate. At block 425, it is determined Yes that the song “Yeah” is being currently played on the Internet radio station in real-time then the song is retrieved from the Internet radio station and the SoCast player program embeds the text “Now taking request, for the all-request lunch hour!” then the song is played on the second computer 105.

At block 427, the second computer 105 determines that the song is not being currently played or is unavailable in real-time then the SoCast player software program utilizes a special algorithm in order to retrieve the Posted example song “Yeah” by the Artist Usher featuring LilJon an Ludacris or any other chosen song. The Artist Usher and song name “Yeah” are normalized by this algorithm to remove or modify erroneous or superfluous data. For example, some stations add special characters to the artist name, such as an asterisk (*) or quotes (“) for internal reasons. These characters make the video search return bad results so these characters are removed by this algorithm. In addition, sometimes artist names contain additional featured artist, i.e. “USHER feat. LILJON AND LUDACRIS” where the featured artists LILJON and LUDACRIS needs to be removed to perform a proper search for “USHER” that includes artist biography and photos. The primary artist information “USHER” is needed not the featured artists “LILJON AND LUDACRIS.” The system separates artist names and searches them independently. Some characters and words don't perform as well with searches so they should be mapped to words more compatible with searches, for example, ampersand (&) should be replaced with the word “and.” Lastly, some artists are commonly misspelled and all variations must be checked, for instance “P!nk” is the official name but “pink” is often used. The SoCast software program includes a database of commonly misspelled names that do these translations.

Within the SoCast algorithm, the Artist “USHER” and the song name “Yeah” are combined with extra filtering keywords in order to create a search phrase to send to the video sharing website application programming interface (API). This search phrase is used to return results of videos. The combination of filtering keywords is to search for the “Song Name by Artist Name” such as “Yeah by USHER” followed by filters for “parody”, “cover”, etc. to remove less relevant videos. At this point, certain keywords are added, such as “official video” and “music video” to reinforce higher quality relevant. After the search is performed and results are received from the application programming interface, then the SoCast algorithm analyzes the videos and selects the first one that can be legally played in the listener's geographic region. For example, YouTube as well as other video sharing websites have particular licensing rules that prevent certain protected video from playing in certain regions. The SoCast player software program opens video via an application program interface (API) and plays it embedded within the player of the second computer 105. Also, the SoCast player software program adds the text “Now taking request for the all-request lunch hour” to the song “Yeah” by the Artist USHER featuring LilJon and Ludacris. The video is from a video sharing website such as YouTube/Vimeo that shows song information, as shown in dialog box 511 of FIG. 5C.

In addition, the SoCast player software program will search on the Internet for information closely related to the Artist name and/or the artist song to be shown in text or played on the video sharing website, such as YouTube/Vimeo or any other video sharing website. Anytime an artist played live and/or Internet radio stream or YouTube/Vimeo on the SoCast player software program the artist name and song information is stored on a separate server on a database. In addition, anytime the artist is played on YouTube/Vimeo as part of the SoCast player software program the artist name and song information is also stored on the separate server 107 on a separate database. This database provides the date, time and the number of times the artist was played on the SoCast player software program and shown on YouTube/Vimeo with the embedded text, which can be readily provided to a company, such as Subway, 91.5fm Defjam, Arista or any other entity in the business of tracking when an artist music is played or shown on YouTube. The sample database may look as follows:

| Artist | Song | Text | Time Played | Device Played On |
|---|---|---|---|---|
| Red Hot | Under the | Subway | 2:00 pm on | Computer 105 |
| Chilli | Bridge | Sandwiches' | 1/5/2012 | |
| Peppers | | Artist of the | 3:01 am on | Computer 101 |
| | | Day is Red Hot | 5/7/2012 | |
| | | Chilli Peppers! | | |
| | | Click here to | | |
| | | redeem your $1 | | |
| | | Coupon | | |
| Usher | Yeah | Now taking | 1:00pm on | Computer 105 |
| featuring | | requests for the | 11/28/2012 | |
| LilJon and | | all-request | 2:00 pm on | Computer 105 |
| Ludacris | | lunch hour! | 12/31/201 | |

At block 429, the user 105a determines if he wants to further distribute the song “Yeah” by Usher featuring LiLJon and Ludacris with the text “Now taking request for the all-request lunch hour! ” in real-time to different users. At block 431 the other user 105a states that Yes she wants to further distribute the song by clicking the “Like” button or “Share” button on second computer 105 as shown in dialogue box 511 (FIG. 5C) to send to different users then the process continues to block 423. At block 433 the user 105a decides not to send the song to more users then the process ends.

This invention provides an integrated computer system that enables a user to post media information on a social networking website that can be retrieved by another user. The user is able to retrieve the media information or song information from an Internet radio station or video sharing website in real-time that is transmitted through a social networking website where the other user can retrieve the song information to either view and hear the song information in real-time or access the song information in real-time from a video sharing website.

Although the present invention has been described above in terms of specific embodiments, many modifications and variations of this invention can be made as will be obvious to those of ordinary skill in the art, without departing from its spirit and scope as set forth in the following claims.

What is claimed is:

1. A system for streaming information from one computer to another computer:
a player computerized system connects through a web interface server into a station community through a social networking website on the web interface server, wherein the station community has media information for a plurality of songs from a website online stream;
the player computerized system determines at least one song of the plurality of songs that have the media information from the website online stream to post on the social networking website;
at least one other player computerized system accesses the social networking website to obtain the post of the at least one song of the plurality of songs that have the media information from the website online stream; and
the at least one other player computerized system determines if the at least one song to post from the plurality of songs that have the media information from the website online stream is available to be streamed in real-time, if the at least one song to post from the plurality of songs that have the media information from the website online stream is available to be streamed in real-time then the at least one song is played on the at least one other player computerized system.

2. The computerized player system of claim 1, wherein the at least one song to post from the plurality of songs that have the media information from the website online stream, wherein the media information includes an artist’ biography, picture of an artist, at least one video of the artist and an artist tour schedule.

3. The computerized player system of claim 1, wherein the website online stream is an Internet radio stream.

4. The computerized system of claim 1 wherein the at least one song to post from the plurality of songs that have the media information from the website online stream, wherein the media information includes a plurality of artist pictures, concert listing of the artist, status update of the artists and a discography of the artist.

5. The computerized system of claim 4 wherein the artist status update is a tweet.

6. A system for streaming information from one computer to another computer:
a player computerized system connects through a web interface server into a station community through a social networking website on the web interface server, wherein the station community has media information for a plurality of songs from a website online stream;
the player computerized system determines at least one song of the plurality of songs that have the media information from the website online stream to post on the social networking website;
at least one other player computerized systems accesses the social networking website to obtain the post of the at least one song of the plurality of songs that have the media information from the website online stream; and
the at least one other player computerized system determines if the at least one song to post from the plurality of songs that have the media information from the website online stream is available to be streamed in real-time, if the at least one song to post from the plurality of songs that have the media information from the website online stream is unavailable to be streamed in real-time then the at least one other player computerized system accesses a special algorithm to retrieve the post of the at least one song from the plurality of songs that have the media information from the website online stream that is played at a video sharing website.

7. The computerized player system of claim 6, wherein the social networking website is Facebook.

8. The computerized player system of claim 6 wherein the video sharing website is YouTube.

9. A system for streaming information with text from one computer to another computer:
a player computerized system connects through a web interface server into a player website, wherein the player computerized system enters text on the player website to place onto a social networking website on the web interface server;
the player computerized system connects through the web interface server into a station community through the social networking website on the web interface server, wherein the station community has media information for a plurality of songs from a website online stream;
the player computerized system determines at least one song of the plurality of songs that have the media information from the website online stream to post on the social networking website, wherein the text is entered on the player website is synced to the at least one song of the plurality of songs that have the media information;
at least one other player computerized system accesses the social networking website to obtain the post of the at least one song of the plurality of songs that have the media information from the website online stream; and
the at least one other player computerized system determines if the at least one song to post from the plurality of songs that have the media information from the website online stream is available to be streamed in real-time, if the at least one song to post from the plurality of songs that have the media information from the website online stream is available to be streamed in real-time then the at least one song is played with the synced text on the at least one other player computerized system.
